(19) United States
(12) Patent Application Publication
(10) Pub. No.: US 2018/0369828 A1
(43) Pub. Date: Dec. 27, 2018

(54) Method and Apparatus for separating organics from a contaminated organics-inorganics waste stream

(71) Applicants: Marc Vanderbeken, Quebec (CA); Cedric Jean-Luc Vanderbeken, Boise, ID (US); Olivier Hugo Christopher Dany Vanderbeken, Sudbury (CA)

(72) Inventors: Marc Vanderbeken, Quebec (CA); Cedric Jean-Luc Vanderbeken, Boise, ID (US); Olivier Hugo Christopher Dany Vanderbeken, Sudbury (CA)

(21) Appl. No.: 15/965,509

(22) Filed: Jun. 19, 2018

Related U.S. Application Data
(60) Provisional application No. 62/523,466, filed on Jun. 22, 2017.
(60) Provisional application No. 62/763,108, filed on Apr. 27, 2018.

(51) Int. Cl. B02C 23/16; B02C 23/10; B02C 19/00; B07B 1/00

(52) U.S. Cl. CPC B02C 23/16; B02C 23/10; B09B 3/0016; B07B 1/00; B02C 19/0018

(57) ABSTRACT

An improved process and apparatus for separating organics and inorganics from waste material with a specific object of preparing the separated organic fraction for the production of biogas or other methods for diverting organics from landfills. Waste material, such as municipal solid waste or source-separated organic waste (SSO), is subjected to a first separation treatment that separates organic and inorganic waste components. The apparatus includes a hopper to receive contaminated organic waste from different sources, a vertical separator that separates the inorganics from the organics by creating a vortex effect in a stationary filtration drum by which the solid contaminants (paper, plastic, metals) are blown in a spiral pattern upwards and removed from the top, while the organic fraction is removed from the bottom.

Such apparatus is improved through novel methods to reduce or eliminate blockages and their associated downtime, and to increase the efficiency of the separation process.

This nonprovisional application claims priority based upon the following prior United States Provisional Patent Application entitled: Method and Apparatus for separating organics from a contaminated organics-inorganics waste stream, Application No. 62/523,466 filed on Jun. 22, 2017 which is hereby incorporated by reference for all purposes.

This nonprovisional application claims priority based upon the following prior United States Provisional Patent Application entitled: Method and Apparatus for separating organics from a contaminated organics-inorganics waste stream, Application No. . . . filed on Apr. 27, 2018, which is hereby incorporated by reference for all purposes.

### BACKGROUND OF THE INVENTION

### Field of the Invention

The present invention relates to improvements to a method and apparatus for processing and depackaging waste materials, such as municipal solid waste (MSW) and food waste materials including source-separated organics (SSO), to be treated prior to further processing such as to be transformed into biogas in an anaerobic digester and consequently transformed into renewable fuels, or to be converted into animal feed additives, organic fertilizers or compost.

### Background Information

The disposal of municipal solid waste (MSW) and food-waste materials has become a problem in the entire world. New regulations require organics to be diverted from landfills or ban completely organics from landfill sites, as well as incinerators. But the organic waste streams are often mixed with packaging materials (plastic wrappings, parts of wooden pallets, or long fibrous wrapping materials) or with inorganics and other non-useful waste streams. The plastic and fibrous wrapping materials cause significant operational problems for equipment designed to separate the useful organic fraction from the other waste streams.

Prior art for separating the useful organic fraction from MSW and from food waste are described in representative patents:
U.S. Pat. No. 4,852,817 (Walter Tipton, Aug. 1, 1989)
GB 2354720 A (Ian Houghton, Apr. 4, 2001)
EP 2006 034 B1 (Giuliano Toninelli, 2006)
US 2016/0296986 A1 (Alessandro Massone, 2016)

The apparatus described within these representative patent documents all have severe operational shortcomings that are prevented with the novel improvements described in the following sections.

### SUMMARY OF THE INVENTION

The present invention has the task of proposing an improved device and a method for the extraction of organics out of a mixed organics-inorganics waste stream or expired pre-packaged food product prior to composting, treatment in an anaerobic digester or transformation in nutrients.
1. The use of chains to pretreat the incoming waste stream and chop up plastic wrappings or long fibrous materials that plug up existing separation apparatus.
2. The use of closely-spaced square or rectangular openings in the screening drum, which removes the useful organic fraction from the waste stream, as opposed to the conventional use of circular. This improvement significantly increases the efficiency and the throughput of the separation process.
3. The use of a tangential discharge at the top of the screening drum, as opposed to a centrally located discharge. This improvement decreases blockage at the discharge to the apparatus and increases capacity.
4. The use of a speed adjustment on the paddle drum in order to adapt the separation process to different feed stocks.

### BRIEF DESCRIPTION OF THE DRAWINGS

Drawing 1 provides a schematic side view of the device for the extraction of organics out of a mixed organics-inorganics waste stream or expired pre-packaged food product. The waste stream (1) is dumped into a feed hopper (2). Two augers (3) & (4) that are located at the bottom of hopper (2) counter-rotate to help prevent waste-stream bridging within hopper (2). Feed auger (4) moves the broken-up waste stream and associated air stream through opening (5) into the bottom of the separation apparatus.

The separation apparatus consists of an outer housing (6) that may be cylindrical or rectangular in cross-section, a cylindrical screening drum (7), an inner rotating paddle-drum (10) with a VFD driven motor(12) and a tangential discharge opening (13). Fastened to the exterior of the rotating paddle-drum (10) are 2 or more breakup chains (8), plus a multiplicity of paddles (11).

The waste stream entering through opening (5) into the bottom of the separation apparatus is further broken up by means of rapidly rotating chains (8) and projected against the inside of the stationary drum. The multiplicity of paddles (11) attached to the inner rotating paddle-drum (10) are inclined at an angle and hence act as propellers to thrust the mixture of air and waste solids in an upwards spiral within the annular space between screening drum (7) and inner rotating paddle-drum (10). The upwards spiral, or vortex, comparable to the movement of a twister or waterspout, throws the waste solids radially outwards due to centrifugal forces acting on the solid particles. The smaller, denser organic fraction can pass through the fixed screening drum (7) and settle down in the space between the screening drum (7)and the housing (6), and discharge through opening (15) for further treatment.

The larger, less aerodynamically dense residual waste (plastic film, wooden fragments, etc.) continue spirally up to the top of the apparatus where they are discharged freely thanks to aerodynamic velocity (13) and hence are expelled (14) from the apparatus.

Drawing 2 provides a view of the square or rectangular filtration areas (7a) in the stationary screen (7).

Drawing 3 provides an abbreviated top view of the device for the extraction of organics out of a mixed organics-inorganics waste stream or expired pre-packaged food product. Rotating paddle-drum (10) with a multiplicity of inclined paddles (11) cause entrained air to be blown upwards and hence cause the particles (14) of waste material to spiral upwards towards the discharge (13).

### DETAILED DESCRIPTION

The apparatus is an improvement to technology known to those involved in the bio-waste reclamation industry and includes a hopper to receive contaminated organic waste from different sources, a vertical separator that separates the inorganics from the organics by creating a vortex effect in a stationary screening drum by which the solid contaminants (paper, plastic, metals) are blown in a spiral fashion similar to a twister or waterspout upwards and removed from the top, while the organic fraction passes through the filtration drum and is removed from the bottom. The apparatus may be complemented by a grit removal system that removes all sand and grit prior to the digester.

A major operational problem with existing apparatus is that the waste stream entering the filtration drum (7) may contain large pieces of plastic wrapping film and or long, fibrous strapping material that eventually wrap themselves around paddles (11) and shaft of the paddle screw and block the apparatus. This blockage requires shutting down the separation process and manually removing the blockage—a labor and time intensive process. It was found by the inventor that this type of fouling and blockage of the paddles can be prevented by attaching 2 or more chains (8) to the outer surface of paddle drum (10) and adjacent to entrance (5). The length of the chains (8) should be longer than the length of the paddles (11). Preferably the links that make up chains (8) should have sharp edges, similar to the chains used on cars and trucks for driving on icy surfaces. The sharp edges help to chop up large pieces of plastic wrapping film and or long, fibrous strapping material but are not essential to this invention, as the primary function of the chains (8) is to throw this large waste material outwards so that it cannot become entangled on paddles (11). The upward movement of the light materials thus starts at the outer position of the vortex and not the center shaft. Hence this invention (the addition of chains (8) to the bottom of the paddle drum (10)) solves a major operational problem with existing separation technologies, where there can be an accumulation of long fibrous material settling at the bottom of the filtration screen.

Another problem with existing apparatus is with the efficiency for organic fraction separation. The perforated drums of existing apparatus use circular perforations that place a limitation upon the process efficiency. The present invention uses square or rectangular perforations that provide, in the case of square openings, considerably more open area than do the existing round openings. This increased area allows for greater throughput or, if desired, a better fractionation of the organic waste stream from the other waste material. Replacing the perforations with square or rectangular openings will increase the drainage of the liquids and at the same time with a rectangular opening with the longitudinal part in the vertical position and the appropriate width decrease contamination of the separated organics fraction.

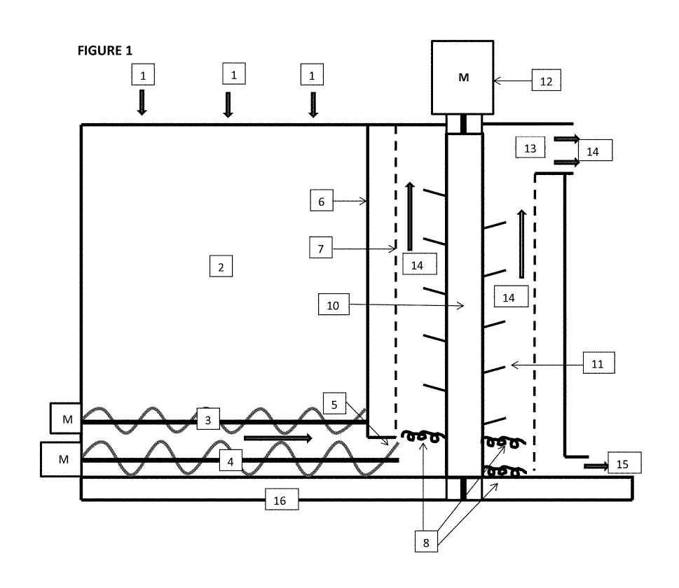

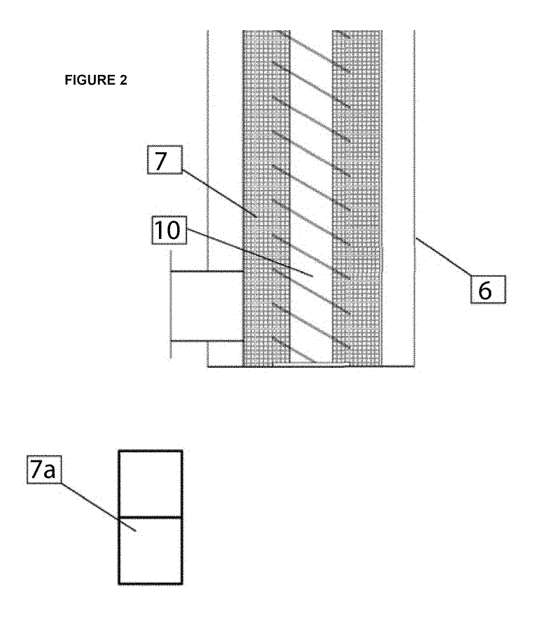

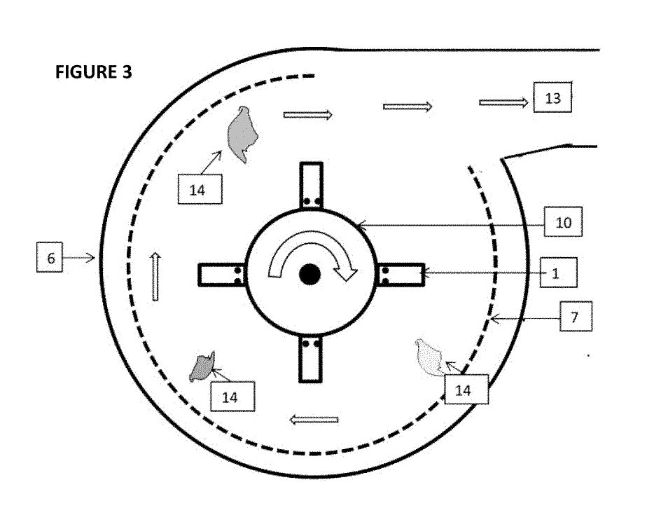

A third novel improvement, which improves the operation of organic waste separation apparatus, is with the location of the discharge (13). Existing systems use discharge and are located at or near the radial-center of the screening drum (7). But this location often results in blockages at the entrance to auger (13) since waste material (14) is blown across the entrance of an auger (13), rather than into the entrance of the discharge (13). The novel improvement, depicted in FIG. 3, is to locate the discharge (13) so that it is tangential to screening drum (7). Waste materials (14) now are blown directly into the exit (13) and are not forced to make a hard 90 degree turn into an auger. This reduces the downtime required for cleaning and hence improves operational efficiency and the amount of contamination that can be expelled. It also removes the friction to the scroll created by the accumulated solids prior to discharge resulting in decreased energy requirement.

A fourth novel improvement is the use of different speeds for the paddle screw driven by a motor(12) with adjustable speeds in function of the different products treated, (SSO, Dry foods, packed vegetables, meats, cans, fruits etc.)

I claim:

1. An apparatus that includes a hopper(2) to receive contaminated organic waste from different sources, and a conveyor(4) that feeds a vertical separator that separates the inorganics from the organics by creating a vortex effect within a perforated drum (7) by which the solid contaminants (paper, plastic, metals) are blown by air in a spiral pattern upwards and removed from the top, while the organic fraction is removed from the bottom, air motion is affected by means of an inner rotating paddle-drum (10) to which a multiplicity of inclined paddles (11)creating a twister effect are attached to its external surface, where fouling of the paddles by plastic wrappings or by long fibrous waste material is prevented by the addition of two or more chains (8) to the bottom of rotating paddle-drum (10).

2. An apparatus that includes a hopper(2) to receive contaminated organic waste from different sources, and a conveyor(4) that feeds a vertical separator that separates the inorganics from the organics by creating a vortex pattern upwards and removed from the top, while the organic fraction is removed from the bottom, air motion is affected by means of an inner rotating paddle-drum (10) to which a multiplicity of inclined paddles (11)creating a twister effect are attached effect within a perforated drum (7) by which the solid contaminants (paper, plastic, metals) are blown by air in a spiral to its external surface and is improved, and its efficiency is increased considerably by making the perforations in perforated drum (7) square or rectangular, as compared with conventional circular perforations.

3. An apparatus that includes a hopper(2) to receive contaminated organic waste from different sources, and a conveyor(4) that feeds a vertical separator that separates the inorganics from the organics by creating a vortex effect within a perforated drum (7) by which the solid contaminants (paper, plastic, metals) are blown by air in a spiral pattern upwards and removed from the top, while the organic fraction is removed from the bottom, air motion is affected by means of an inner rotating paddle-drum (10) to which a multiplicity of inclined paddles (11)creating a twister effect are attached to its external surface, and is improved by discharging (13) tangentially by air flow at the top of the perforated drum (7), instead of removing with a discharge screw at the conventional top-central location.

4. An apparatus as described above in claim 1 where the length of the chains (8) are greater than the radial dimension of paddles (11) but shorter than the radial distance between paddle-drum (10) and the perforated screening drum (7).

5. An apparatus as described above in claim 4 where the links of the chains (8) are square in cross-section or otherwise fabricated so as to provide sharp edges that facilitate their chopping action and therefore breakup plastic film and long fibrous wrapping material.

6. An apparatus as described above in claim 4 where the chains (8) are made of a strong, wear-resistant metal or plastic material or a combination of metal and plastic materials. Examples would include carbon steel links, stainless steel links and Kevlar-wrapped and joined metal weights.

7. An apparatus as described above in claim 1 where the speed of the paddle drum is adjustable thus allowing to adapt to different feed stocks
